(19) United States
(12) Patent Application Publication
(10) Pub. No.: US 2012/0084092 A1
(43) Pub. Date: Apr. 5, 2012

(54) METHOD AND APPARATUS FOR A COMPREHENSIVE DYNAMIC PERSONAL HEALTH RECORD SYSTEM

(76) Inventors: Michael J. Kozuch, Pleasanton, CA (US); Tom Eliaz, Oakland, CA (US); Wallace J. Luke, III, Pleasanton, CA (US)

(21) Appl. No.: 13/211,308

(22) Filed: Aug. 17, 2011

Related U.S. Application Data
(60) Provisional application No. 61/389,371, filed on Oct. 4, 2010.

(51) Int. Cl. G06Q 50/00

(52) U.S. Cl. 705/2

(57) ABSTRACT

We present a data-driven system that seamlessly integrates the compilation of a diverse set of patient electronic medical records, family history, and environmental risk factor databases, a program that determines correlations and assigns weights through a neural network between illness and the state of symptoms, a program to create disease-specific questionnaires and content, a program alert that informs users of trends and potential illness outbreaks due to anomalous changes in regional or national symptom trends, and a program that enables medical practitioners to view patient-generated records and manage an online referral system. The automated diagnoses and alerts allow users to make informed and rapid medical treatment decisions.

### CROSS-REFERENCE TO RELATED APPLICATION

This application claims priority from Provisional Application 61/389,371 by the same inventors, filed on Oct. 4, 2010.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

### Field of Invention

The present invention relates to the field of personal health records, and particularly a system of integrated elements that links clinical decision-support tools, the management of health records, and the mapping of environmental risk factors to specific illnesses.

### DEFINITIONS

Epigenetic—changes in the genetic expression that is caused by factors other than changes in the underlying DNA sequence. In the case of disease, epigenetic causes are non-hereditary and may be attributed to any one or multiple environmental factors.

Environmental risk factors—any external agent such as pollutants or toxins which are either natural or man-made. These agents include airborne gases or particulates, groundwater chemicals or contaminants, soil chemicals or pollutants, pesticides, herbicides, electromagnetic radiation (including, but not exclusively, UV radiation, X-rays, microwave, radio or noise), and physical or psychological stress.

Biological Risk Factors—distinct from the environmental risk factors, typically inorganic or physical, are the biological risk factors that take into consideration the presence of micro-organisms that may create pathogens, alter metabolisms, or in some manner disrupt the normal functioning of the human physiology. These microbes may reside either within a person's body or outside.

EMR (electronic medical record)—a database of patient medical records and clinical data that is maintained through a software application or service on the premises of a hospital, clinic or private physician practice. Data entry into an EMR is almost exclusively by medical staff.

PHR (personal health record)—a database of patient health records that is maintained through an online software application or service. Data entry, modifications and access control is dictated by the patient.

### DISCUSSION OF BACKGROUND

The ability to quickly identify and treat illness is becoming increasingly necessary to meet the increasing volume of patients faced by physicians, minimize the cost of extended patient care, limit medical liabilities, and deal with the enormous complexity of medical conditions. There are numerous hospital institutions that are moving to digitize patient medical records to facilitate the exchange of records between institutions, however this has proven to be a slow and expensive endeavor to execute.

The cost of preventable medical errors is now approximately $29 billion per year and continues to escalate. This cost to society is reflected in the loss of productivity, the cost of extended medical care, and the cost of drugs and treatments (that may or may not be appropriate). It does not include the cost of malpractice.

With the onset of fatigue, increasing numbers of patients seen per day, the enormous volume and complexity of medical information, and the threat of malpractice, doctors are under severe pressure to perform well. The benefit of rapid and accurate diagnosis of illness would be a valuable tool for doctors to get patients into the right treatment as soon as possible.

Numerous electronic medical record (EMR) systems have emerged in the commercial marketplace. However, most, if not all, of these systems are designed to store patient data (chart notes, patient histories, lab results, etc), yet none of the systems that we encountered actually performs any analytics on any portion the data. In addition most of the systems are designed to facilitate the billing and reimbursement of doctor procedures and tests, rather than concentrate on the treatment of an individual's illness.

Finally, there are some systems that attempt to diagnose illness based on symptoms; however these systems are not tied to medical records and often provide far too many diagnoses for a given set of symptoms to be of practical value. Part of the problem stems from the fact that the auto-diagnostic systems most commonly used rely on medical encyclopedias or databases that contain the average or predominant symptoms associated with illnesses. Some of the newer developments use branching tree structures or relational databases in their logic, but these systems are very large, rigid and are not able to cope with symptoms that might be common to multiple illnesses. Neural networks are just now beginning to emerge in radiological diagnosis and interpretation. Neural networks and systems that reflect adaptive learning have been used in a multitude of engineering applications and are slowly working their way into medical practice.

As genome projects gather momentum in mapping the genetic code of humans and other life forms, there will greater emphasis placed on identifying a patient's predisposition to certain illness based on his or her genetic makeup. While this information will be useful in identifying the risk of illness, there is no actual guarantee that the individual will develop that condition. It is for this reason that we look to the environment for biological causes that trigger illness.

Epigenetic factors that contribute to disease depend upon the exposure of individuals to biological, chemical, electromagnetic or any kind of adverse stress factors that interact with their physiology to bring about illness or changes in physiology or chemistry. Therefore, our approach looks to identify all the principal factors and patterns that might trigger a physical reaction leading to an illness or anomalous physiological behavior. While there are numerous studies identifying a plethora of these triggers, there is no integrated platform that incorporates all the environmental risk factors to which an individual might have been exposed during his or her lifetime. When individuals are unable to adapt to changes in their environment, then the landscape of stress conditions will trigger adverse physiological reactions leading to illness. In the extreme case, biological systems that refuse to change with the environment eventually become extinct.

Of increasing interest is the role that microbes play in the manifestation of disease. Within every human being lies an ecosystem of 500-1000 species of micro-organisms. If one considers the genetic makeup of these organisms, this translates into nearly 4 million nonhuman genes, one hundred times the number of human genes. These microbes play a significant role in human physiology and metabolism through their secretions and interactions. In recent years, mapping the genetic makeup of these microbial genes has lead to a new understanding of how a modification (through evolution, mutation, or hybridization) of these genes or portions thereof could lead to drug-resistant strains of microbes or the development of DNA strands that account for encoding pathogenic factors like toxins. Microbes are now thought to be involved in the development of kidney stones, Crohn's disease, diabetes, multiple sclerosis, prostate cancer, breast cancer and a host of other illnesses. Therefore, the genetic markers of microbes now need to be included in the human genome profile if we are to fight disease and personalize medicine.

With all the advances in disparate areas of medicine and technology, the remaining challenge has been to collate the plethora of available information into a format that empowers physicians to make critical diagnostic and treatment decisions while saving time and money.

### SUMMARY OF THE INVENTION

We have invented a new technique and apparatus that correlates and recognizes patterns in an individual's symptoms associated with local environmental risk factors, personal biological risk factors (such as genotype variants in particular gene markers or variants of microbial genes), medical history, family histories of illness, and a plethora of health parameters to allow meaningful and accurate diagnosis of illnesses, diseases or any medical conditions that require treatment. The present invention includes the design of an integrated system of components that provide a new approach and methodology to diagnose symptoms of illness in order to enable doctors and medical practitioners to quickly diagnose medical conditions and ensure proper and immediate treatment and record keeping. The system also provides alerts when a series of symptoms emerge for multiple individuals in the database or when symptoms reach a rate of change that might reflect the outbreak of an illness or require immediate attention. There is also immense predictive value in the invention in that treatments can also be recommended based on patterns of prior treatments.

The present invention aggregates a large number of environmental risk factors for an individual given the individual's location of residence or employment. While survey questions may contribute to logging the individual's perception of risk factors such as pesticide use, the new technique capitalizes on the use of Geographic Information Systems or other geographically diverse data such as highway networks, airport locations, etc., to automatically calculate the distance from the individual's location to the nearest point of the risk exposure. The present invention also automatically logs the length of time and total exposure to environmental risk factors to which an individual may be subjected.

For example, the individual may enter her current location as a street address and the number of years at that location. While it is possible to ask individuals what they believe their proximity is to a particular pesticide, the process of pulling this information from external databases can be automated so that more accurate answers can be calculated. In addition, when the process is automated and performed “in the background”, then the distance and intensity of any source of risk can be calculated as long as that data is available for the computation.

To perform the computation, the computer only requires the individual's street address. The conversion of the street address to a latitude and longitude is readily available elsewhere. Once the latitude and longitude is known, then the distance to the nearest landfill, factory, airport or any other data point can be calculated. Many of these point sources may be sources of airborne emissions which can be hazardous to an individual's health or well being.

It is also possible to calculate the distance from the individual's location to the nearest point on a line such as a highway or railroad. Datasets of transportation, power, and other networks are readily available and usually consist of many data points that link the linear features. In other words, in many geographic information systems, a highway that spans 5 miles might consist of a dozen latitude and longitude points on a map that are joined by a line. The distance to the nearest point can be found or, alternatively, a simple geometric calculation would allow the estimate to be computed to the nearest location on the line. This distance can then be logged.

Finally, it is also possible to calculate the distance from an individual's location to the nearest point of an area or polygon on a map. Datasets of pesticide, herbicide or other hazardous areas are available as shapefiles in Geographic Information Systems (GIS). The shortest distance between the individual's location and the polygon can be computed or alternatively the distance between the individual and the center or centroid of the polygon can be computed. Many of these computations may readily be performed in a GIS.

The present invention also correlates and recognizes patterns in symptoms associated with environmental risk factors specific to an individual, her medical history, family histories of illness, and a plethora of additional parameters to allow meaningful and accurate diagnosis of illness, disease or any medical condition that requires treatment. The present invention includes the design of an integrated system of components that provide a new approach and methodology to diagnose symptoms of illness in order to enable doctors and medical practitioners to quickly diagnose medical conditions, automatically record symptoms and key indicators, and ensure proper and immediate treatment. The system also provides alerts when a series of symptoms emerge in the database or reach a rate of change that might reflect the outbreak of an illness or require immediate attention. There is also immense predictive value in the invention in that treatments can also be recommended based on patterns of prior treatments.

In one embodiment, the present invention provides a differential diagnostic process that integrates diverse data sets in conjunction with current patient patterns in order to estimate a future state. Although the present invention focuses on patient illnesses, from a broader perspective, the occurrence of any event or risk can be modeled using similar processes so long as sufficient diverse datasets related to the event or risk are available.

Finally, through our office portal we enable a host of physicians to view patient records through an on-line referral system. This system is meant to automate the process by which a physician allows other specialists to view patient records (through a referral) and provides a means for primary care providers to view records while patients are being treated by specialists. The system will also notify the patient of new physicians who gain access to their records through the physician-to-physician referral mechanism. The patient will then have the ability to allow or disallow such access.

Portions of both the device and method may be conveniently implemented in programming on a general-purpose computer or on networked computers, and the results may be displayed on an output device connected to any of the general-purpose or networked computers, or transmitted to a remote device for output or display. In addition, any components of the present invention represented in a computer program, data sequences, and/or control signals may be embodied as an electronic signal broadcast (or transmitted) at any frequency in any medium including, but not limited to, wireless broadcasts, and transmissions over copper wire(s), fiber optic cable(s), and co-ax cable(s), etc.

### BRIEF DESCRIPTION OF THE DRAWINGS

A more complete appreciation of the invention will be readily obtained by reference to the following detailed description when considered in connection with the accompanying drawings, wherein:

FIG. 1 is a high level flowchart of an integrated system of elements in an automated personal health record system according to an embodiment of the present invention;

FIG. 2 is a flow diagram of the comprehensive data entry by the patient into both electronic medical records as well as into the system that will lead to diagnosis according to an embodiment of the present invention;

FIG. 3 is a flow diagram of the disease monitor system according to an embodiment of the present invention;

FIG. 4 is a flow diagram of the office portal for doctors or medical administrators according to an embodiment of the present invention;

FIG. 5 is a flow diagram of the external inputs to the system according to an embodiment of the present invention;

FIG. 6 is a drawing illustrating the clustering association between different symptoms due to the presence of different risk factors according to an embodiment of the present invention;

FIG. 7 is a drawing illustrating the conceptual configuration of multiple input datasets and outputs in a neural network according to an embodiment of the present invention;

FIG. 8 is a drawing illustrating how multiple data points taken over time can add additional information to pattern recognition algorithms.

FIG. 9 is a flow diagram of the content creation system according to an embodiment of the present invention.

### DESCRIPTION OF THE PREFERRED EMBODIMENTS

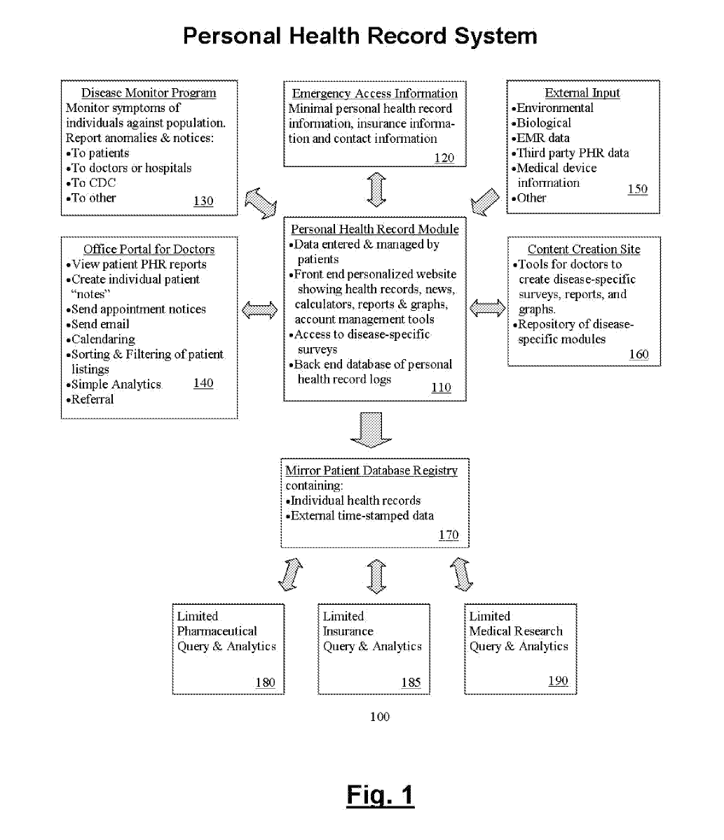

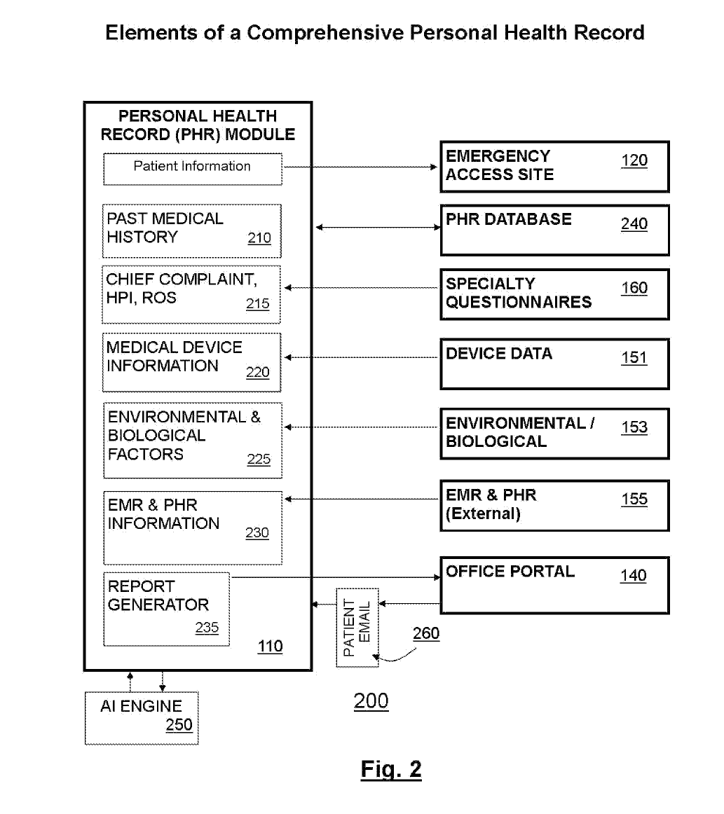

Referring now to the drawings, wherein like reference numerals designate identical or corresponding parts, and more particularly to FIG. 1 thereof, there is illustrated an overview of a system of integrated elements for a personal electronic health record system 100 which includes the collection, management and display of patient inputs and support features in a personal health record module 110, a module which allows the automatic creation of an emergency access site 120, a program that stores and retrieves an individual's health record to a database of similar attributes of a population of patients 240 (as shown in FIG. 2), a disease monitor program that tracks changes in rates of illness or symptoms across populations of individuals 130, an office portal for doctors and medical administrators that allows physicians to view patient records 140, a module that allows for the comprehensive acquisition of relevant external data 150, a module that allows for the creation and storage of new surveys by doctors 160. Once the personal health module 110 creates and writes all the pertinent information collected in a session to the health records database 240 and into a report 235 (as shown in FIG. 2) it is copied and mirrored to another database 170 which allows for limited and personal-identification-redacted data mining, analysis and querying by individuals from the pharmaceutical industry 180 and the insurance industry 185, as well as for medical research 190. Insurance and pharmaceutical access is distinguished from medical research access since research queries and analysis may differ substantially from industry data mining needs.

FIG. 2 illustrates the comprehensive features of an integrated personalized patient health record 200 including a system to enter patient data through electronic questionnaires. Initially, a patient will register on the site to establish an account and will submit contact information, respond to security questions, provide the names of doctors and specialists, and furnish any important information such as medical insurance numbers, emergency contacts and demographic information. Individuals can also be asked questions to help personalize their site (such as color, layout, etc.) and establish viewing permissions.

Some or all of the information gathered up to this point may be duplicated and directed to an emergency access information module 120. Just as one carries a spare tire in one's car, having access to critical health or medical information can be useful in the event of an emergency, particularly if the individual is unable to communicate with her physician. Supplementing the emergency contact information, allergies, medications, current illnesses or conditions, insurance information and any other information deemed pertinent by the patient can also be recorded on this site. This site is a read-only site such that its contents cannot be altered by anyone but the patient. An easy way to enable a third party to access this site would be to have the PHR site generate a card with the emergency site address (such as URL or phone number) and an access code. This card can be regenerated at any time by the patient with a new access code in the event of a lost or stolen card.

Once the patient account is established, there are a number of ways in which to proceed depending upon how the individual was brought to the site. One option is to have individuals respond to a series of questions about their past medical history 210. This will include questions about allergies, immunizations, surgical history, childhood and recent illness, medication history (including alternative remedies and supplements), family history, and social/behavioral history. Also included here are questions about where they live, where and when they have traveled, employment history, level of education, and other demographic information.

Should an individual be asked to respond to disease-specific questions by her doctor, then the past medical history questionnaire can be answered at a later time.

With respect to disease-specific questions, patients will be directed to a unique questionnaire 160 such as for asthma. They will then proceed to answer a multitude of questions about their asthmatic symptoms in the standard medical format of chief complaint and health and present illness (HPI) 215. As the patients respond to questions, the responses will automatically be populating a report that contains tables, graphs, and text 235. Some of the responses will also be applied to statistical or analytic calculations that might appear in the report. Once a session is terminated and the report is generated 235, it is time stamped and an electronic log is kept of each individual response in the PHR database 240.

At this time, patients have the option to import any medical device information 151 into a corresponding module 220 that aggregates all such information for the report and within their personal health record module 110. This can be done across platforms (such as html) and communication protocols (such as SMS or voice). The importance of device information is that it provides quantitative information in addition to the qualitative information that the patient provides through the symptom and disease questionnaires. This can substantially enrich the information displayed in the reports.

At this point, environmental and biological risk data 153 are imported into an environmental/biological module 225 either by an individual (patient) or automatically. The module 225 will select data that is site-specific in that it will contain environmental information that contains attributes both close in time and location to where the patient spends significant amounts of time. These data may include any one or more of the following: geologic and soil information, hydrological information, highway and rail network locations, high voltage power line network locations, natural hazard or disaster information, pollutant (manmade or natural) data, emission and air quality data, weather data (pressure, temperature, humidity, ozone, wind speed & direction), ultraviolet radiation, space weather data (such as lunar cycle, solar flare incidence, ionospheric data, geomagnetic storms or storm indices), noise data (e.g., airport, factory, or road), pesticide/herbicide data, geochemical (e.g., soils, aquifers, or stream) data. The biological risk factors would include the identification of specific strains of micro-organisms that reside within an individual or those that are within some distance such that it poses a hazard to the individual, as well the genomic information about the micro-organisms showing genetic markers that indicate a microbe's predisposition to a particular function or change which may ultimately adversely affect the individual. This means that we are now including microbial genomes, pertaining to an individual, alongside the individual's human genome as an indicator of a susceptibility to disease.

Finally, we are providing the ability to import data through an EMR processing module 230 from other personal health records or electronic medical records 155. This allows individuals to cross check any information they have submitted through our system and enhance their personal health records. Duplicate records of any field of information can readily be deleted.

All the information collected will be converted into a comprehensive report through the report generator 235 which aims to enable a physician to quickly see the current state of illness of a patient and where she lies in her continuum of care. This circumvents the need for a physician to read through a large number of charts for each patient encounter. Our report will include a summary page with information about the disease, current medications, past tests and procedures, risk indicators, and any other pertinent information that the physician or specialist requires to quickly determine the next course of treatment. Other pages might include plots that show similar information on a timeline, contact information for referring physicians, or notes from the patient or physician's last encounter. This salient information is meant to further enable doctors to grasp current patient status with respect to the history of the patient's illness. The report will only be visible to the physician through an office portal for physicians 140. This portal is also meant to be a physician conduit for communication 260 with the patient. Additional features in this portal will be addressed shortly.

For each disease-specific report that is generated, the entire time-stamped record will consist of a multitude of fields (including past medical history, environmental risk factors, biological risk factors, device and EMR information) that are fed to an artificial intelligence engine 250. This allows the engine to “learn” about all the multitude of variations in symptoms and risk factors for that particular illness. The ultimate goal of this exercise is to allow the engine to automatically categorize illness when an individual submits a series of symptoms to the system. In order to do this, a sufficient number of sessions with patients that have a common illness are required in order to minimize the error rates in the automatic diagnosis. While many systems use a predetermined number of data inputs to train their neural networks, our system is designed to continually learn and adapt regardless of the number of patients. The reason for developing an adaptive system is to be able to handle the diagnosis or treatment of diseases that changes over time. A flu virus that mutates or becomes resistant to specific drugs is such an example.

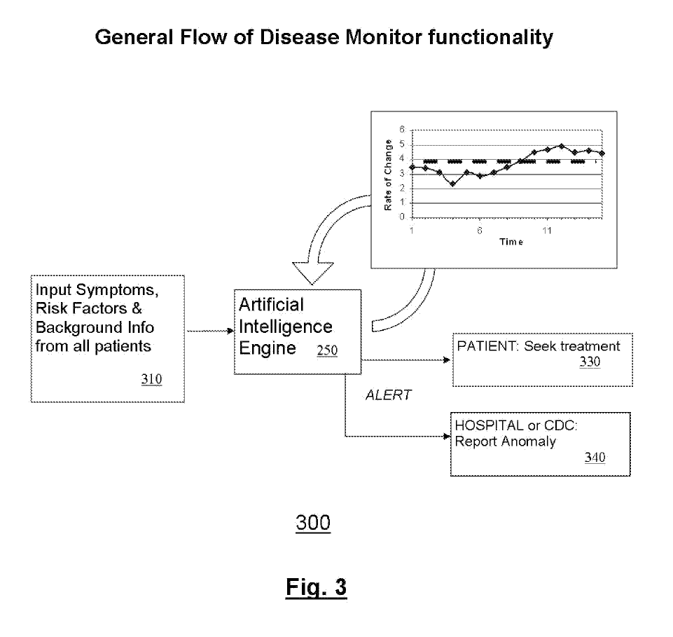

FIG. 3 illustrates an example of the disease monitoring process 300 in which all of the patient medical record and new symptoms 310 are entered into an artificial intelligence engine 250. The network will then search for anomalous rates of change of similar symptoms or illness against a population in either a local, regional, or national area. Once these symptoms reach a threshold rate of change, which usually indicates how fast the symptom or disease is spreading, an alert is sent to all hospitals in the system or the Center for Disease Control (CDC) 340. Alternatively, if an individual is entering her symptomatic information remotely (e.g., at home) prior to an appointed admission and the artificial intelligence engine decides that a certain threshold of criticality is reached, then an alert will be sent to the patient to immediately come in to a hospital for treatment 330.

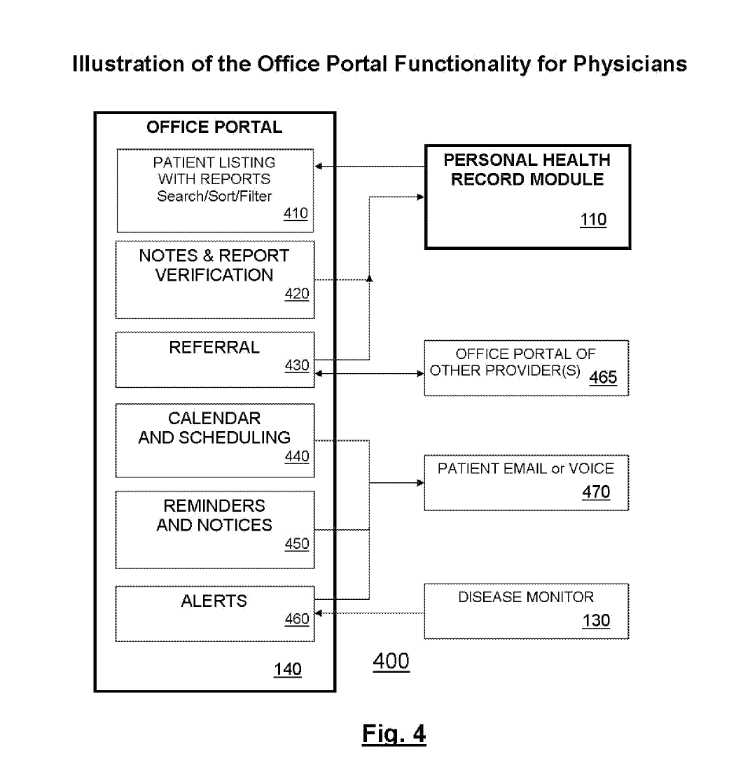

A diagrammatic representation of the office portal for physicians is depicted in FIG. 4. The primary function of the portal is to allow viewing of the patient reports for physicians, specialists or medical administrators. Therefore, once the report is automatically imported from the patient's personal health record module 110, it can then be posted and sorted in a number of ways in the office portal 410 as long as the patient is registered in the system and has granted the physician permission to view her information. Listings of patients and their reports can be sorted in alphabetical order by patient name, patient phone number, disease, location or any number of listed attributes. The office portal also contains a number of administrative features that can facilitate the enrollment of new patients. One feature is the appointment scheduling module 440. New patients are registered by entering their name, email address, appointment date and the questionnaire that will be needed prior to the next appointment. The system will then automatically notify the patients informing them of their appointment date along with a link to the full registration pages and disease questionnaires 450. Patients will receive the reminders via email, SM, voice or other communication protocols 470. Automatic reminders can go to patients on a regular basis, say every 3 days or weekly, until the system detects that they have both registered and answered the appropriate questionnaire 450.

Another feature of the portal includes the ability for a physician to enter limited information into the patient health record, such as a diagnosis 420. The process by which the physician reviews the patient symptoms and report information in order to enter a diagnosis or accept an automated diagnosis constitutes the physician verification of the data. Should physicians decide to enter additional (doctor) notes, they can create and open a new document which allows them to enter patient information (observations, medications, data) in a free format. This document is saved as an additional attachment (separate from the patient health report) for each patient within the office portal. The advantage to this approach lies in keeping a patient-managed document separate from that of the doctor-managed document.

The referral feature allows the physician to enter the contact details of another physician or specialist whom they deem necessary to assist the patient in providing treatment or care 430. If the doctor to whom the patient has been referred already has an account, then the patient and report will automatically appear in that doctor's portal 465. Should the referred doctor not have an account, then the system administrator will receive a notice to contact the new physician for setting up an account. An important part of the referral system is that patients are also notified when new doctors are entered into their network of physicians with access to their records. In this manner, patients have the opportunity to allow or disallow access to their records.

Finally, a powerful feature to the office portal is the ability to show alerts 460. These notices are triggered when the system detects changes in the report which are anomalous and warrant special attention by the physician. This might include a change in symptoms by the patient to a new medication, a sudden reaction to a medication, or any other information that the physician has deemed important enough to be addressed with relative urgency. The list of alert triggers is designed with the questionnaire development, and when the office portal account is set up for new doctors, they can opt in or out to receive alerts or alter the triggers' thresholds themselves. At the discretion of the physician, alerts can also be sent to the patient via phone, email, SMS, or other protocols 470.

Another feature in our system is the inclusion of external inputs which can be of major assistance in the diagnosis of disease. FIG. 2 illustrated how medical device data 151 or information can be directly imported into personal health records 220. In some cases it will be necessary to obtain secure access (identification and passwords) from separate device accounts in order to import the data into the personal health record. The device information may be imported as prefabricated reports or as a string of text data. The same approach can be applied to external personal health records (PHR data) or electronic medical records (EMR) that often reside in clinics or hospitals.

A unique feature to our external inputs is the ability to include environmental risk factors which are known to be major contributory causes of disease or illness. A list of potential environmental data types has already been given (e.g., geochemical, air emissions, weather, etc.).

For the following discussion, the hazard site represents the location or source of a particular pollutant or disease trigger. The exposure site represents the location where an individual or patient resides or works, and the total exposure we seek may also be thought of as the total dosage of a pollutant that the exposure site receives.

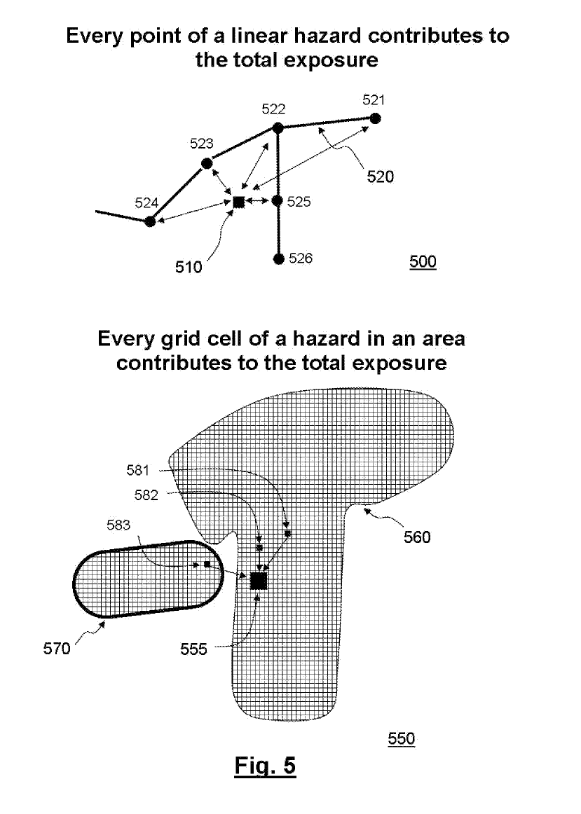

The total exposure, E_{T}, of a site to a multitude of disease risk factors, triggers or hazards is illustrated in FIG. 5 and may be represented by

$$\begin{matrix}{E}_{T} = Σ Hazards \\ = Σ {c}_{m} {P ( t )}_{m} + Σ {k}_{i , j} {L ( t )}_{i , j} + Σ {b}_{k , l} {A ( t )}_{k , l}\end{matrix}$$

where P(t) represents the concentration of a hazard attributed to point sources such as smoke stacks at a particular point in time t, L(t) represents the hazards attributed to linear sources such as road networks at some time t, and A(t) represents the hazards attributed to sources confined to areas such as a dump site at some time t. In a typical road network 500, road segments can be broken down into a series of points 521, 522, 523, 524, 525, 526, each of which of can be thought of as a source of pollutants for the site 510 where a patient might reside or work or otherwise spend significant amounts of time. Similarly, for areas of pollutants 550 where two regions 560 and 570 or more exist where pesticides have been applied, the areas can be represented as a collection of points on a grid such as 581, 582, 583 that are independent sources of the pesticide. Each of these points contributes to the total exposure at a site 555. From the equation above, c, k, and b are coefficients that account for factors such as wind speed, wind direction, hill slope, aquifers or other transport mechanisms, etc., which might enhance or dilute the hazard between the source and the site in question. Depending upon the hazard type, the coefficients may be functions that take the form of diffusion rates, geometric spreading or other functions. A geographic information system (GIS) is an ideal mechanism for performing these calculations where instrumental measurements taken at an exposure site are unavailable and where multiple hazard types can be considered simultaneously.

Finally, another order of complexity enters the equation when temporal variations of the hazard sources or the duration of the exposure is needed. Logging the initial time and duration of exposure is required for determining the total exposure or dosage, D, since many illnesses may result from a total accumulated exposure and not from a single dose of exposure. This is given as

D=Σₜ

The GIS is optimally designed to reformat and store the hazard data elements in a central database repository, log the patient location (exposure site), compute the temporal exposure for each hazard type, and calculate the nearest distance and total dosage for each hazard source.

As the system collects the numerous patient data and environmental data for hundreds or thousands of patients, disease clusters will become apparent over time, where diseases can be correlated with the presence of individual hazards or pollutants or combinations of them.

Another embodiment of this application would be to diagnose unknown illnesses from patterns of any multitude of symptoms and environmental factors using artificial intelligence such as a neural network. While the diagnosis of the potential of a particular illness is established using statistical pattern recognition techniques inherent in the neural network, there is also a physical basis for changes in the potential of an illness. The human body can be thought of existing in a metastable state, and the presence of a risk factor acts to increase the stress on that point, thereby causing a mutation, lapse in physiological function or illness. Should multiple risk factors be present at the same location and point in time, then the probability of an illness or symptom is increased. This predictive value of the invention can also be used in recommending treatment for particular illnesses where treatments under different environmental conditions yield different results. For example, a patient who normally would require penicillin as a treatment for a specific illness might be allergic to this drug. In this case the allergy represents the environmental risk factor, and so another drug would be recommended. Many other more complex examples exist with more obscure risk factors. The integration of a multitude of databases and environmental risk factors onto a common platform can also be used in the screening of individuals for clinical studies as well as the real-time monitoring of the use of pharmaceuticals in the marketplace.

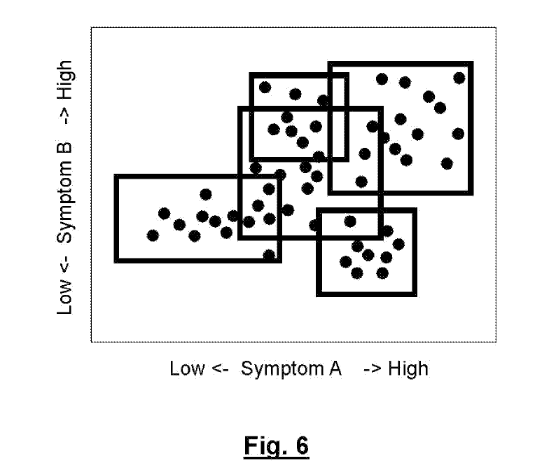

FIG. 6 illustrates the process of how symptoms might be related to other symptoms. Alternatively, symptoms can be plotted against other environmental risk factors. It is expected that there will most likely be groupings or clusters that emerge in these plots. The dimensions and spread of each cluster is due to other environmental risk factors that might influence the plotted symptoms to a greater or lesser degree. The artificial intelligence software maps out these variations and is therefore able to take subtle variations and determine weights of influence to determine the final diagnosis. It is expected that there may be several overlapping clusters and therefore there can be several weighted combinations of symptoms and environmental risk factors that influence the final diagnostic outcome.

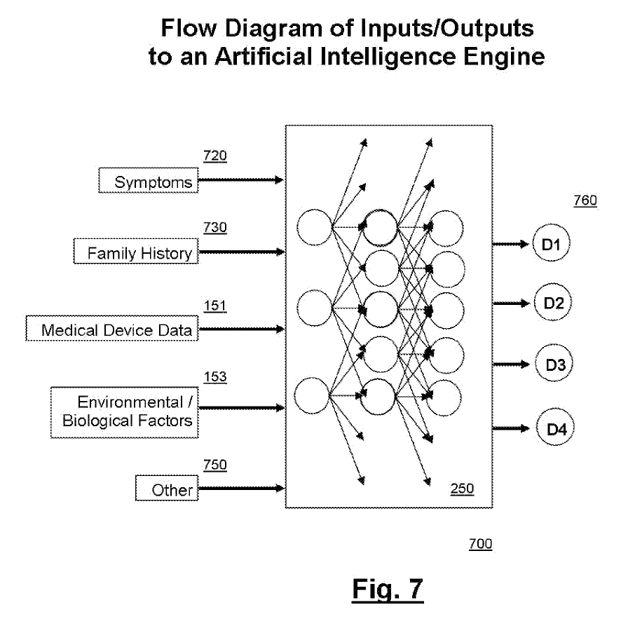

Neural networks are a common form of artificial intelligence software that is used to simulate the complex structure of neural connections in the brain or living organisms. FIG. 7 illustrates how a specific outcome (or disease) is the result of a multitude of interdependent processes or influences (700). The artificial intelligence engine 250 may take the form of a simple feed-forward neural network with a single or multiple hidden layers, a back-propagation network, a Hopfield network, or any other single or combination of neural network architectures that lead to optimal solutions. The weights of each of the neural connections are equivalent to the weights of overlapping symptoms that were shown in FIG. 6. Inputs to the neural network include all the patient symptoms 720, their medical and family history 730, demographics and external inputs which include medical device data 151, environmental/biological data 153, EMR data, the user's genetic profile and that of his or her microbes and any other 750 inputs that are determined to influence disease processes. The artificial intelligence engine output consists of a single or multiple disease possibilities and probabilities or treatment options 760 which would be printed in the patient health record.

The data-driven rules employed by neural networks can also be improved upon by adopting neurofuzzy algorithms (e.g., fuzzy logic) which can yield significantly more rules to include nearly all of the data parameters such as in FIG. 7. These algorithms incorporate the benefits of both neural networks and fuzzy logic, including the ability to: dynamically extract knowledge from the data to “learn” and rapidly improve its performance over time, allow weights to be readily adjusted continuously, create fuzzy models that can explain very complex systems with simple rules, and combine qualitative (e.g., linguistic) and quantitative information.

Neurofuzzy algorithms have the ability to calculate all the correlations and assign trigger weights to all the data types simultaneously. Neurofuzzy algorithms have been widely used by control engineers in designing video cameras, controlling subway systems, flight control, etc. A key feature of neurocontrol is that these systems lend themselves to control systems whose dynamics are highly nonlinear and unknown or uncertain. Other examples can be found in neurofuzzy systems that control wheel wear, obstacle avoidance behavior of mobile robots, image processing, and the control of carbon monoxide levels at traffic intersections in Japan.

In the present embodiment of our system, the artificial intelligence engine can be employed in both the monitoring of symptoms or the spread of disease, FIG. 3, as well as in the diagnosis of illness based on an individual's personal health record and environmental risk factors, FIG. 7.

As an alternative to using a neural network or some other form of artificial intelligence, one might log the presence and intensity of symptoms. This log can then be called upon as a pattern recognition tool to be used in the diagnostic process. For example, if three different symptoms are present at a similar time and location, then future simultaneous occurrences of those symptoms would imply that the same illness might be present in other patients or could be forthcoming in areas where similar anomalous risk factors are present.

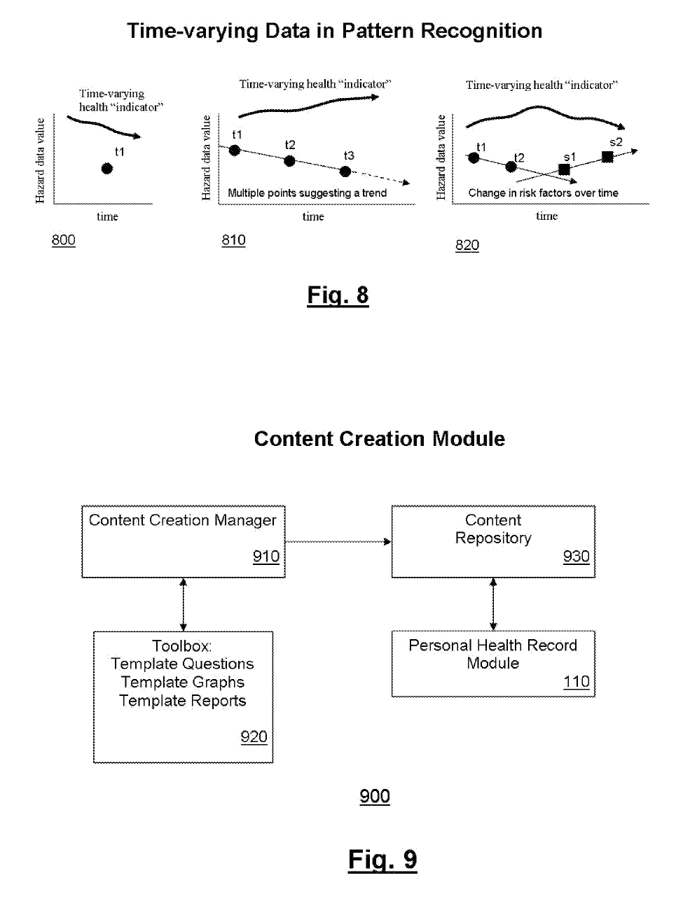

An important feature of data collection is to acquire and incorporate more than a single entry of a particular data type, such as the current dose of medication, into the string of inputs (FIG. 8). A single data point is limiting in that nothing is known about the prior state of the data type relative to the ongoing change in health of the individual 800. Without more than one measurement of a data type (such as medications or an environmental risk factor, for example) it is difficult to know if or by how much that data type is related to the onset of illness. However, by including multiple “historical” data points, a trend might become apparent which might lead to a better understanding of where the data might be headed at some future point in time 810. So, for example, one might conclude that the drop over time of a particular hazard risk factor could be the reason for the improvement in an individual's health. The more time-varying data types that are considered, the better one might be able to build causal relationships between the hazard risk factors and the state of a patient's health 820. Alternatively, should the state of the patient remain the same in the midst of changing medications or environmental factors, then other treatment options can be pursued or a search can be made for other potential causes of the illness. An example that was already mentioned is that of the flu virus which is known to mutate or become drug resistant over time. In a neural network, this is performed automatically, but where no such artificial intelligence is available, then it might be critical to know why a patient is ill in the midst of multiple changing medications or environmental risk factors, or whether there is statistical independence or dependence between any of the input parameters. The ability for the system to evolve or adapt over time to changing circumstances is a distinguishing feature to this approach.

FIG. 9 illustrates another important aspect of our system and that is the creation of disease-specific questionnaires and the repository for the questionnaires. Any doctor or specialist who is creating content in the form of disease-specific questions for the system is issued an account 910 and access code. It is here that the doctor is allowed to use a toolbox 920 that consists of a series of template questions and responses, template graphs and plots, and template reports. With this suite of tools, a customized question set and report is able to be produced and deposited in the repository 930 for access by the personal health record module 110. It should be noted that while our system is designed to diagnose a particular illness from a small number of questions, medical providers still require a complete chart or report in order to manage a patient's disease over time. This is often regarded as the continuum-of-care. Therefore, while a quick diagnosis is a valuable feature of our system, the fact that it then directs the patient to answer additional questions about that particular illness is essential to the complete and long term documentation of that particular illness.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CDRW+/−, micro-drive, and magneto-optical disks, ROMs, RAMs, EPROMs, EEPROMs, DRAMs, VRAMs, flash memory devices (including flash cards, memory sticks), magnetic or optical cards, MEMS, nanosystems (including molecular memory ICs), RAID devices, remote data storage/archive/warehousing, or any type of media or device suitable for storing instructions and/or data.

Stored on any computer readable medium (media), the present invention includes software for controlling both the hardware of the general-purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer-readable medium further includes software for performing the present invention, as described above.

Included in the programming (software) of the general-purpose/specialized computer or microprocessor are software modules for implementing the teachings of the present invention, including, but not limited to, collecting medical data, correlating medical data, establishing triggers and weights, broadcasting alerts based on correlated data, triggers, and weights, and applying alerts to emergency management and other markets, and the display, storage, or communication of results according to the processes of the present invention.

The present invention may suitably comprise, consist of, or consist essentially of, any element of the various parts or features of the invention, and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

Plainly, this invention is as applicable to the treatment of animals as humans. While this invention was conceived to address pressing needs in the medical field, it can be seen that it is readily adaptable to other arenas in which entities require “healing”, such as automobiles or airplanes, or machinery of any sort. Mechanics and repair technicians (the analogs to medical professionals) would collect information and “vital signs” in much the same way and enter the information into the system, which would have access to analogous databases and which would supply and be supplied information concerning alerts (in this arena “epidemics” would equate to the discovery of disproportionate numbers of faulty or failing parts, and the alerts would lead to recalls). Thus, while the descriptions herein have focused on medical applications, they can all be seen to have their analogs in other applications.

We claim:

1. An electronic personal health record system for recognizing and correlating at least one health parameter associated with a user, which may be a human being or animal or robot or other machine, for providing meaningful and accurate diagnosis of at least one health condition, the system comprising:
at least one personal health record module for storing at least one datum associated with the at least one health condition;
at least one emergency information access module designed for the automatic creation of at least one emergency access site;
at least one software program designed for storing and retrieving the at least one health parameter;
at least one disease monitoring software program designed for tracking changes in rates of illness and/or symptoms related to the user;
at least one web portal designed for allowing a medical professional to access a plurality of patient records;
at least one external input module designed for the comprehensive acquisition of at least one external datum; and
at least one content creation module designed for creating and storing at least one health condition survey related to the user by the medical professional;
whereby the system may be designed for linking a plurality of clinical decision support tools, managing a plurality of patient health records and mapping a plurality of environmental risk factors and a plurality of biological risk factors to a plurality of illnesses.

2. The electronic personal health record system of claim 1 wherein the system may include at least one database.

3. The electronic personal health record system of claim 1 wherein the at least one health parameter may be a plurality of medical history details, a plurality of environmental risk factors and a plurality of personal biological risk factors.

4. The electronic personal health record system of claim 1 wherein the plurality of environmental risk factors may include pollutants, toxins, airborne gases, particulates, ground water chemicals, contaminants, soil chemicals, pesticides, herbicides, electromagnetic radiations, physical stress and psychological stress.

5. The electronic personal health record system of claim 1 wherein the plurality of personal biological risk factors may include micro-organisms responsible for creating pathogens that may alter metabolism and disrupt the normal functioning of the human physiology.

6. The electronic personal health record system of claim 1 wherein the at least one web portal may be designed for viewing the at least one data associated with the at least one health condition by the medical professional.

7. The electronic personal health record system of claim 1 wherein the at least one web portal includes a plurality of administrative features that may be utilized for enrolling a new user and/or for entering the at least one health condition of the user by the medical professional.

8. The electronic personal health record system of claim 1 wherein the at least one portal may be designed for showing alerts when the system detects variations in the at least one datum associated with the at least one health condition.

9. The electronic personal health record system of claim 1 wherein the user may have the option to import at least one medical device information into a corresponding module that aggregates all information within the at least one personal health record module.

10. The electronic personal health record system of claim 1 wherein the at least one datum associated with the at least one health condition may be a medical chart note, a medical history report and/or a laboratory result of the user.

11. The electronic personal health record system of claim 1 wherein the at least one health parameter may be transmitted and/or received by at least one electronic communication medium.

12. The electronic personal health record system of claim 1 wherein the system may include at least one artificial intelligence engine for identifying the at least one health parameter.

13. The electronic personal health record system of claim 12 wherein the at least one artificial intelligence engine may include a plurality of neural networks.

14. The electronic personal health record system of claim 12 wherein the at least one artificial intelligence engine may be designed for monitoring and diagnosing the symptoms associated with the at least one health condition, and for diagnosing the at least one health condition itself.

15. The electronic personal health record system of claim 1 wherein the system may be designed to generate a plurality of comprehensive reports for monitoring and diagnosing the symptoms associated with the at least one health condition of the user.

16. A method for recognizing and correlating at least one health parameter associated with a user, which may be a human being or animal or robot or other machine, for providing meaningful and accurate diagnosis of at least one health condition, the method comprising the steps of:
(a) registering on a site by or for the user to create a patient account;
(b) establishing the patient account to the user;
(c) entering a set of information of the user in the site;
(d) sending the set of information to an emergency information access site;
(e) asking a plurality of questions related to the at least one health condition of the user;
(f) responding to the plurality of questions with a plurality of answers by or for the user;
(g) generating at least one comprehensive report based on the plurality of answers provided by or for the user;
(h) time stamping the at least one comprehensive report; and
(i) sending the at least one comprehensive report to at least one artificial intelligence engine for monitoring and diagnosing the symptoms associated with the at least one health condition.

17. The method of claim 16 wherein the set of information associated with the user includes contact information, security questions, names of medical professionals, medical insurance numbers, emergency contacts and demographic information.

18. The method of claim 16 wherein the plurality of questions related to the at least one health condition of the user includes:
disease-specific questions, including symptoms of the disease, medical history and family history;
medical device data;
environmental risk factors, including data related to pollutants, toxins, airborne gases, particulates, ground water chemicals, contaminants, soil chemicals, pesticides, herbicides, electromagnetic radiations, physical stress and psychological stress; and
biological risk factors, including data related to micro-organisms responsible for creating pathogens that may alter metabolism and disrupt the normal functioning of the human physiology.

19. The method of claim 16 wherein the at least one artificial intelligence engine may be designed for receiving a plurality of data inputs such as data related to the at least one health condition, medical history data, family history data, medical device data, environmental risk factor data, biological risk factor data, electronic medical record (EMR) data and genetic profile data of the user.

20. The method of claim 16 wherein the at least one artificial intelligence engine may be designed for sending a plurality of data outputs such as data related to the possibility, probability and treatment option of the at least one health condition.
